(19) United States
(12) Patent Application Publication
(10) Pub. No.: US 2019/0077003 A1
(43) Pub. Date: Mar. 14, 2019

(54) WEARABLE APPARATUS AND SYSTEM FOR USE WITH OUTDOOR POWER EQUIPMENT

(71) Applicant: HUSQVARNA AB, HUSKVARNA (SE)

(72) Inventors: Eric Lennings, Huskvarna (SE); Fredrik Edholm, Jönköping (SE)

(21) Appl. No.: 16/081,270

(22) PCT Filed: Mar. 1, 2017
(86) PCT No.: PCT/SE2017/050188

§ 371 Date: Aug. 30, 2018

(30) Foreign Application Priority Data
Mar. 1, 2016 (SE) 1650264-3

(51) Int. Cl. B25F 5/00; G08C 17/02; G05B 19/05

(52) U.S. Cl. CPC B25F 5/00; G06F 1/16; G05B 19/05; G08C 17/02

(57) ABSTRACT

A wearable device configured to be worn by an operator of outdoor power equipment may include processing circuitry having a processor and memory. The processing circuitry may be configured to communicate with a paired device during operation of the paired device over a first communication link. The processing circuitry may be further configured to provide an operational control function associated with operation of the paired device.

### TECHNICAL FIELD

Example embodiments generally relate to outdoor power equipment and, more particularly, relate to a wearable device (e.g., a wristband) that can be used to facilitate tracking and operation of outdoor power equipment.

### BACKGROUND

Property maintenance tasks are commonly performed using various tools and/or machines that are configured for the performance of corresponding specific tasks. Certain tasks, like cutting trees, trimming vegetation, blowing debris and the like, are typically performed by hand-held tools or power equipment. The hand-held power equipment may often be powered by gas or electric motors. Similarly, walk-behind and ride-on outdoor power equipment are used for specific tasks like lawn mowing, tilling, snow removal, etc., and these devices can have gas or electric motors.

The outdoor power equipment described above is typically operated in relatively harsh environments, and performs difficult tasks that require mobility. The mobility of these devices is certainly a big advantage, and efforts are continuously made to improve the utility and mobility of such devices. However, the ease with which these devices can be transported may also, in some cases, make the device more susceptible to theft or unauthorized/inappropriate use. Moreover, even the rightful owners/operators of such devices may not be properly using the devices.

Thus, it may be desirable to provide a way by which to track or monitor the operation of such devices, but do so in a way that does not further add to the complexity, cost or weight of such devices.

### BRIEF SUMMARY OF SOME EXAMPLES

Some example embodiments may provide a wearable device that can be tracked or monitored in connection with the use of one or more pieces of outdoor power equipment. The wearable device (e.g., wristband) may be paired with an outdoor power equipment device and allow the operation and/or location of the device to be tracked, monitored or even restricted. The safety, productivity and security of the device may therefore be enhanced, but the device itself may need only minimal additional components added thereto so that the weight, cost and complexity of the device is not adversely impacted.

In one example embodiment, a wearable device is provided. The wearable device may be configured to be worn by an operator of outdoor power equipment and may include processing circuitry having a processor and memory. The processing circuitry may be configured to communicate with a paired device during operation of the paired device over a first communication link. The processing circuitry may be further configured to provide an operational control function associated with operation of the paired device.

In another example embodiment, an outdoor power equipment device is provided. The outdoor power equipment device may include a motor, a working element operably coupled to the motor to be powered by the motor, and communications circuitry. The communications circuitry may be configured to communicate with a wearable device worn by an operator of the outdoor power equipment device over a communication link. The wearable device may provide an operational control function associated with operation of the outdoor power equipment device.

In still another example embodiment, a system is provided that may include a wearable device and a paired device. The wearable device may be configured to be worn by an operator of outdoor power equipment. The paired device may be configured to be paired with the wearable device via wireless communication over a first communication link. The paired device may include a motor, a working element powered by the motor, and communication circuitry configured to communicate over the first communication link. The wearable device may include processing circuitry configured to communicate with the paired device during operation of the paired device over the first communication link. The processing circuitry may be further configured to provide an operational control function associated with operation of the paired device.

Some example embodiments may improve the user experience, safety, productivity and/or the security of outdoor powered equipment.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a concept diagram of a system in which a wearable device may operate in accordance with an example embodiment;

FIG. 2 illustrates a block diagram of circuitry for connecting the wearable device to a paired device in accordance with an example embodiment;

FIG. 3 illustrates a control flow diagram for operation of the wearable device in accordance with an example embodiment;

FIG. 4 illustrates a control flow diagram for another scenario involving operation of the wearable device in accordance with an example embodiment; and

FIG. 5 illustrates a control flow diagram for still another scenario involving operation of the wearable device in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection or interaction of components that are operably coupled to each other.

Some example embodiments may provide for a wearable device (e.g., wristband, smart watch, helmet, glove, pants, etc.) that can be useful in connection with operating powered tools or vehicles that may generally be referred to as outdoor power equipment or devices. Outdoor power equipment of all types may employ some form of processing circuitry thereon to facilitate operation of such devices. The processing circuitry can range from very simple to complex. Thus, the thought may arise to further increase the capability of such devices to fully integrate them into the so called “Internet of things” by providing them with complex processing and communication equipment. However, the cost of such improvements can be prohibitive, and may not be necessary. Moreover, the weight of such devices may be adversely impacted.

Some example embodiments may allow certain functionality that might otherwise be integrated into the outdoor power equipment itself, thereby increasing cost and weight, to be instead implemented in a wristband (as one example of a wearable device that is configured to be worn on the wrist of the operator) that can be paired with the equipment. The provision of a wearable device that can accompany the user (and perhaps be registered to specific users or to various classifications of users) and can be paired with the equipment or even enable (or conditionally enable) functions or operation of the equipment can therefore even further expand the capabilities of the system to track, protect, monitor, functionally enable or otherwise interact with the equipment and/or the user (e.g., via the wearable device). The wearable device may therefore, in effect, become a license to operate the corresponding equipment.

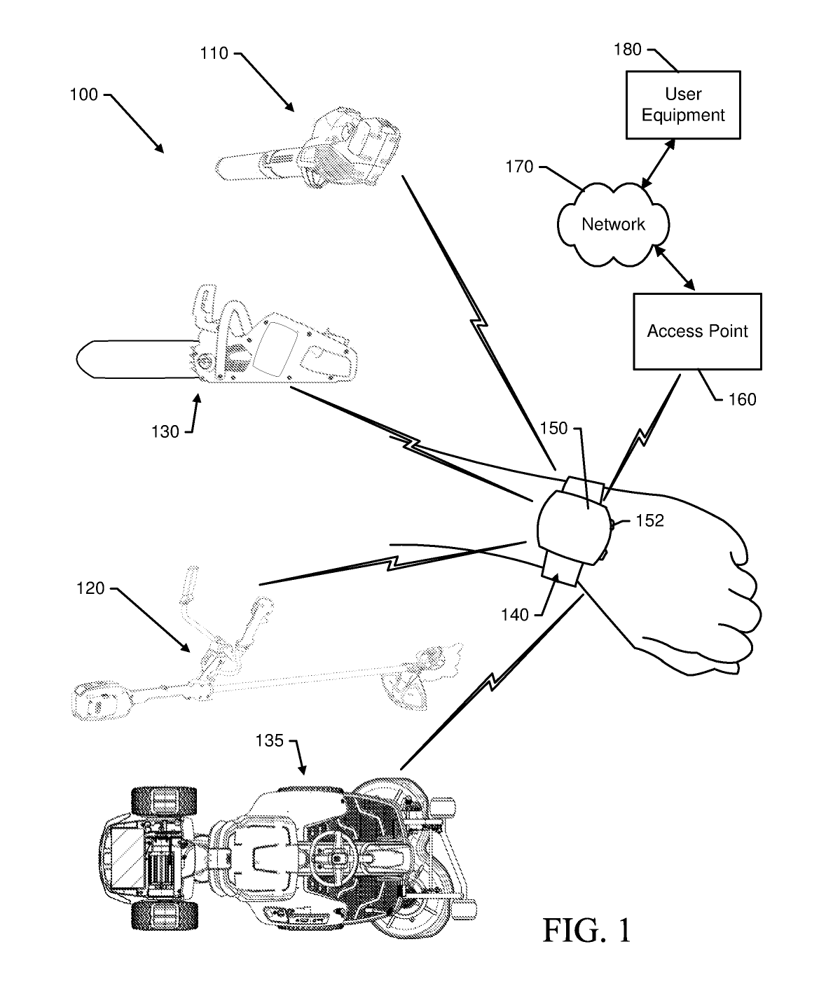

FIG. 1 illustrates a concept diagram of a system 100 in which a wearable device of an example embodiment may operate. As shown in FIG. 1, the system 100 includes a plurality of individual pieces of outdoor power equipment including a first device 110, a second device 120, a third device 130, and a fourth device 135. Each of the first, second, third and fourth devices 110, 120, 130 and 135 includes at least an electric motor, a working element powered by the electric motor, and a battery pack as described herein. However, it should be appreciated that example embodiments are equally applicable to gas powered devices, or devices powered by mains power. The system 100 also includes a wearable device (e.g., wristband 140) for a user or operator to wear while operating any of the first, second, third and fourth devices 110, 120, 130 and 135. The wristband 140 is configured to be placed in wireless communication with any of the first, second, third and fourth devices 110, 120, 130 and 135 via a first communication link. In some cases, the system 100 may further include an access point 160. The access point 160 may enable the wristband 140 to be operably coupled to a network 170 to which user equipment 180 may be connected via a second communication link.

The wristband 140 may include, among other things, a display 150 and one or more function buttons 152. The display 150 and function buttons 152 may form a portion of a user interface, as described in greater detail below. However, it should be appreciated that such user interface could take various forms and have various levels of complexity and capability. Thus, in some cases, the display 150 could be fairly simple and have minimal information provided thereat. For example, an indication of the device to which the wristband 140 is paired, and other simple indications regarding normal or abnormal operating conditions may be provided in some cases. Meanwhile, in other cases, much more information and interaction could be accomplished at the display 150 and with the function buttons 152. However, in some cases, most user interface (or at least detailed or complicated user interface operations) may be accomplished on-line or off-line at the user equipment 180. Moreover, the wristband 140 of some examples may not include a display at all. Thus, for example, the wristband 140 of some embodiments may only act as a communication device to record, transmit or relay information associated with the operator or with operation of the device to which the wristband 140 is paired.

In the pictured example, the first device 110 is a blower, the second device 120 is a trimmer, the third device 130 is a chainsaw, and the fourth device 135 is a riding lawn mower. However, these three example devices are merely shown to illustrate the potential for interoperability of the wristband 140 with a plurality of different types of devices in the outdoor power equipment context. Thus, other pieces of outdoor power equipment could be substituted or added in other examples. For example, string trimmers, hedgers, walk-behind lawn mowers or other devices could be utilized in connection with other example embodiments. Any powered piece of outdoor power equipment that can be operably coupled to the wristband 140 for either communication purposes or the other functionalities described herein, could be part of the system 100, and the system 100 could include as few as a single device or as many as dozens of devices.

Additionally, the fact that four devices that could be employed in connection with the wristband 140 are shown is merely illustrative of the potential for multiplicity relative to the number of devices that a single instance of the wristband 140 can work with. It should be appreciated that multiple wristbands could be employed in some cases to interact with a different set of devices, with the same set of devices, or with selected ones of overlapping sets of devices. Thus, in some cases, a number of different instances of the wristband 140 can communicate with the access point 160 (or multiple access points distributed geographically) to access the network 170, and various individual pieces of user equipment 180.

In an example in which a single instance of the wristband 140 is used with a set of devices (e.g., the first, second, third and fourth devices 110, 120, 130 and 135), the single instance of the wristband 140 may, in some cases, interact with only one of the devices at a time while the operator is using the corresponding one of the devices. The device being used may be electronically paired with the wristband 140 and any data captured or generated by the wristband 140 may be stored or communicated in association with an identity of the device to which such data pertains. Thus, although all of the devices can communicate with the wristband 140, it should be appreciated that the wristband 140 typically only communicates with one such device at a time (i.e., the device to which the wristband 140 is paired).

In some cases, the wristband 140 may simultaneously, or separately and sequentially, wirelessly communicate with one of the devices (e.g., the first, second, third and fourth devices 110, 120, 130 and 135) and with the access point 160. However, wireless communication with the access point 160 is not required in all cases. Thus, for example, the wristband 140 may be configured to communicate with the access point 160 continuously, in burst transmissions that occur at intervals determined by temporal or event driven stimuli, when the wristband 140 is docked with the access point 160 or otherwise physically coupled thereto, or by operably coupling a removable memory of the wristband 140 to the access point 160.

In some cases, the wristband 140 could be paired with or used in connection with operation of respective different ones of the first, second, third and fourth devices 110, 120, 130 and 135 at respective different times. The device with which the wristband 140 is paired at any given time may be referred to as a paired device, and may be a selected one of the first, second, third and fourth devices 110, 120, 130 and 135. In such cases, the wristband 140 may receive or generate operation information that is descriptive of various aspects of the operation of the paired device as described in further detail below. The wristband 140 may also receive or generate operator information that is descriptive of various parameters associated with the operator of the paired device as described in further detail below. Additionally or alternatively, the wristband 140 may perform one or more operational control functions (e.g., device security functions, alarm functions, electric engine control, etc.) with respect to the paired device as described in further detail below.

The operational control functions may enable or disable operation of the paired device, or may restrict certain operational features of the paired device. The operational control functions may also or alternatively provide alarm or notification services, locally or remotely. In some cases, the operational control functions may ensure the correct (or authorized) user is wearing the wristband 140 while operating the paired device. Moreover, the paired device may be immobilized or otherwise rendered inoperable if the paired device is not used in connection with the correct (or authorized) user, or if the user is improperly employing the paired device (e.g., based on the operation information and/or operator information).

The operator information may include vibration data, which determines or records vibration levels encountered while the operator is using the paired device. The operator information may also or alternatively include heart rate monitoring, temperature/moisture measurement, proximity data (to other users or objects), noise levels and/or other environmental information that can be sensed and that may impact operator health and/or safety. As such, in some cases, the operator information may include measured physiological parameters of the operator. The operator information may be recorded and compared to various thresholds (locally or remotely) to enable the operator to be informed if unsafe or unhealthy situations are noticed. If unsafe or unhealthy situations are noticed based on the operator information, then the operator (or other personnel) may be informed after the fact or in real-time. In some cases, a distress alarm button may also be provided for the operator to request help, and thus a call for help may also be considered as operator information.

The operation information may include information indicative of run time (or run hours) of the paired device, numbers of on-off cycles, GPS positioning of the wristband 140 (and therefore also the paired device), service data, working data of various types (e.g., for optimization of operation), and/or the like. In some cases, the operation information may include engine RPM, working assembly RPM, torque, position, orientation, temperature data, speed data, mode of operation, lubricating oil pressure or level, instances of protective actions, and/or the like. The operation information may be used to facilitate improvement of operator productivity, and may also provide input that can be used to monitor for safety related protective functions.

In some cases, the operation information and/or operator information may be stored locally at the wristband 140, or stored remotely in the network 170 or at the user equipment 180. As discussed above, if remote storage is employed, the storage may occur after communication of such information from the wristband 140 using the communication protocol employed to provide the information to the network 170 or user equipment 180. It should also be appreciated that the wristband 140 may have different triggers or stimuli that cause the wristband 140 to communicate with the access point 160 (if applicable) and/or the device being paired with the wristband 140. In some cases, initiation of connection of the wristband 140 with a paired device (e.g., the first, second, third or fourth devices 110, 120, 130 or 135) may trigger communication. Alternatively or additionally, termination of connection may trigger communication, or various time or event based triggers may cause the wristband 140 to initiate communication and extract or otherwise generate or receive data.

Once data (such as the operation information and/or operator information) has been extracted from devices to which the wristband 140 is operably coupled (e.g., paired, linked, connected, etc.) or from the environment or operator, the data may be stored locally at the wristband 140 or at the user equipment 180 and/or the network 170, or analyzed (in real-time or post hoc) at one of the corresponding locations. The network 170 may therefore be a local area network, or a wide area network (e.g., the Internet), and the user equipment 180 could be a personal computer or laptop, a smart phone or tablet, a server, or any of a number of other such devices. The access point 160 and/or the paired device may communicate with the wristband 140 via short range wireless communication (e.g., Bluetooth, WiFi, and/or the like), and the access point 160 may have a wired or longer range wireless connection to the network 170 and/or to the user equipment 180, although short range connection is also possible. Moreover, in some cases, if the user equipment 180 has, for example, Bluetooth communication capabilities, the user equipment 180 could actually act as the access point 160. Thus, for example, in some cases, the access point 160 could be a communication node that provides a gateway to the network 170 so that user equipment that is capable of communication with the network 170 can interface with the wristband 140. However, in other cases, the access point 160 could be a smart phone with Bluetooth capability and the user can interact directly with the wristband 140 without other network resources therebetween to receive information from the wristband 140 and interact with the wristband 140.

As may be appreciated from the discussion above, the wristband 140 includes communication circuitry to support communication with the access point 160 and/or with the paired device (e.g., a selected one of the first, second, third and fourth devices 110, 120, 130 or 135). Thus, the wristband 140 is configured to be operably coupled to the system on two levels, only one of which is required. First, there is a primary communication level of connectivity to the paired device, which can support all three of the operation information, operator information and operational control functions. Secondly, there is a secondary communication level of connectivity to the network 170 and/or the user equipment 180, which is optional.

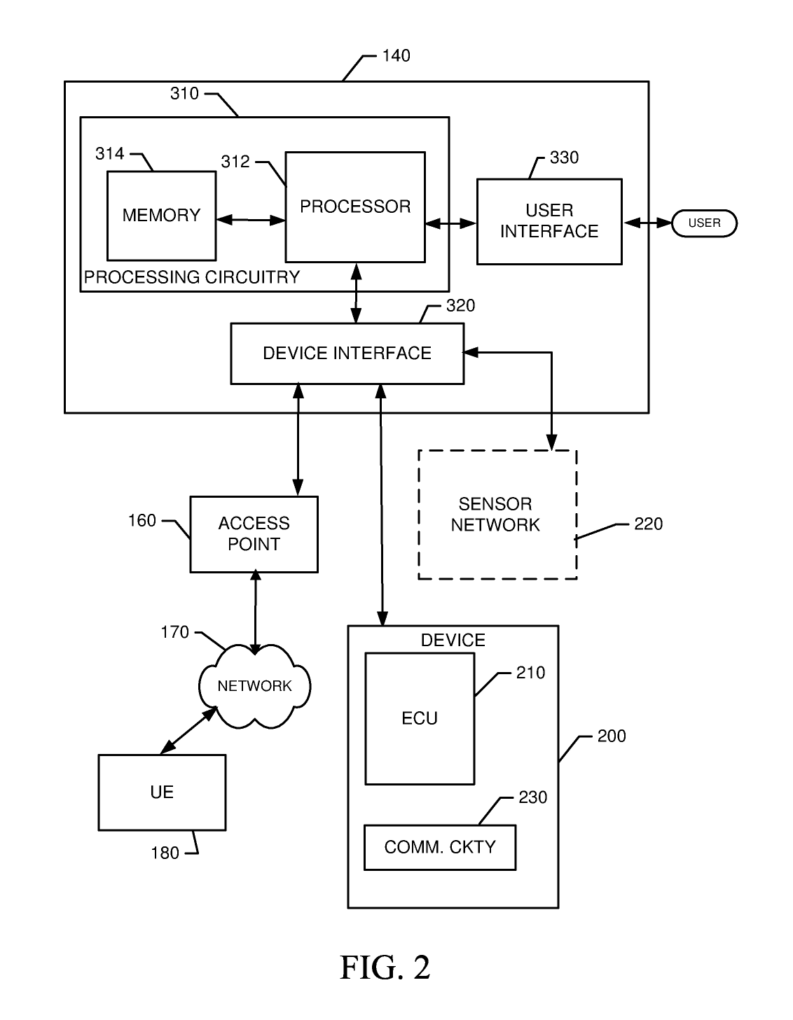

FIG. 2 illustrates a block diagram of circuitry that may be employed to support various operations of the wristband 140, and some of the functionality associated therewith. In this regard, as shown in FIG. 2, the wristband 140 may be operably coupled to the access point 160 and a paired device 200. The access point 160 may be further operably coupled to the network 170, which may be operably coupled to the user equipment 180. The device may include an electronic control unit (ECU) 210. The ECU 210, which may include processing circuitry for controlling various components of the paired device 200, may control a working assembly (e.g., a blade, mobility assembly, starting circuitry, trimmer head, electric motor, and/or the like) of the paired device 200 and may also gather data (e.g., operating parameters) that form a portion of the operation information. In some cases, some of the operation information may be provided by various sensors of a sensor network 220. The sensor network 220 may include various sensors provided on the paired device 200. However, FIG. 2 shows the sensor network 220 in a dashed box separate from the paired device 200 because at least some sensors of the sensor network 220 (and sometimes all of them) may be located elsewhere (e.g., on the wristband 140). The sensors of the sensor network 220 may include, for example, a GPS receiver, accelerometer, vibration sensors, temperature sensors, speed sensors, pressure sensors, heart rate sensors, and/or the like.

The paired device 200 may also include communications circuitry 230 that may enable the paired device 200 to communicate wirelessly with the wristband 140. The communication circuitry 230 may enable WiFi, Bluetooth, or other short range wireless communication (e.g., over the first communication link). However, in other cases, the communication circuitry 230 may additionally or alternatively provide a means by which the paired device 200 can receive an authorization code or qualified user identifier transmitted by the wristband 140 to enable or authorize operation of the paired device 200. In such cases, the wristband 140 may act as an access control mechanism or a license for operation of the paired device 200. Thus, for example, the paired device 200 may be inoperable unless an authorized user (as indicated by the authorization code or qualified user identity) is in control of or in proximity to the paired device 200. In some cases, the paired device 200 or the wristband 140 may include an RFID tag or other readable tag that a reader on the other of the two devices can read to determine whether the wristband 140 constitutes authorization to operate the paired device 200.

As further shown in FIG. 2, the wristband 140 may include processing circuitry 310 of an example embodiment as described herein. In this regard, for example, the wristband 140 may utilize the processing circuitry 310 to provide electronic control inputs to one or more functional units of the wristband 140 and to process data received at or generated by the one or more functional units regarding various indications of device activity (e.g., operation information and operational control functions) relating to the paired device 200 and/or sensed parameters about a particular user (e.g., operator information). In some cases, the processing circuitry 310 may be configured to perform data processing, control function execution and/or other processing and management services according to an example embodiment. As such, the processing circuitry 310 may be configured to manage extraction, storage and/or communication of data received or generated at the processing circuitry 310.

In some embodiments, the processing circuitry 310 may be embodied as a chip or chip set. In other words, the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control other components or modules that interface with the processing circuitry 310. As such, the processing circuitry 310 may be embodied as a circuit chip (e.g., an integrated circuit chip) configured (e.g., with hardware, software or a combination of hardware and software) to perform operations described herein. In some embodiments, the processing circuitry 310 may be embodied as a portion of an on-board computer housed in the wristband 140 to control operation of the wristband 140 relative to its interaction with other devices (e.g., the paired device 200 and/or the access point 160).

Although not required, some embodiments of the wristband 140 may employ a user interface 330. The user interface 330 may be in communication with the processing circuitry 310 to receive an indication of a user input at the user interface 330 and/or to provide an audible, visual, tactile or other output to the user. As such, the user interface 330 may include, for example, a display (e.g., display 150), one or more switches, lights, buttons or keys (e.g., function buttons 152), and/or other input/output mechanisms. In an example embodiment, the user interface 330 may include one or a plurality of colored lights or a simple display to indicate charge status or other relatively basic information. However, more complex interface mechanisms could be provided in some cases. Alternatively or additionally, the user interface 330 could be embodied remotely, such as at another device of the network 170, at the user equipment 180 or at the paired device 200. The user interface 330 (whether embodied locally at the wristband 140, or at another remote location) may further include alarm functionality to provide notifications and/or alarm signals.

The wristband 140 may employ or utilize components or circuitry that acts as a device interface 320. The device interface 320 may include one or more interface mechanisms for enabling communication with other devices (e.g., paired device 200, the access point 160, and/or internal components/sensors of the sensor network 220). In some cases, the device interface 320 may be any means such as a device or circuitry embodied in either hardware, or a combination of hardware and software that is configured to receive and/or transmit data from/to components in communication with the processing circuitry 310 via internal communication systems of the wristband 140. With respect to the wristband 140, the device interface 320 may further include wireless communication equipment (e.g., a one way or two way radio) for at least communicating information from the wristband 140 to the access point 160. As such, the device interface 320 may include an antenna and radio equipment for conducting Bluetooth, WiFi, or other short range communication with the access point 160 and/or paired device 200, or for employing other longer range wireless communication protocols for communicating with the access point 160 in instances where the access point 160 is directly associated with provision of access to a wide area network.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein.

In an example embodiment, the processor 312 (or the processing circuitry 310) may be embodied as, include or otherwise control the operation of the wristband 140 based on inputs received by the processing circuitry 310. As such, in some embodiments, the processor 312 (or the processing circuitry 310) may be said to cause each of the operations described in connection with the wristband 140 in relation to operation the wristband 140 relative to undertaking the corresponding functionalities associated therewith responsive to execution of instructions or algorithms configuring the processor 312 (or processing circuitry 310) accordingly.

In an exemplary embodiment, the memory 314 may include one or more non-transitory memory devices such as, for example, volatile and/or non-volatile memory that may be either fixed or removable. The memory 314 may be configured to store information, data, applications, instructions or the like for enabling the processing circuitry 310 to carry out various functions in accordance with exemplary embodiments of the present invention. For example, the memory 314 could be configured to buffer input data for processing by the processor 312. Additionally or alternatively, the memory 314 could be configured to store instructions for execution by the processor 312. As yet another alternative or additional capability, the memory 314 may include one or more databases that may store a variety of data sets responsive to input from the paired device 200, or any other functional units or devices from which the wristband 140 has previously extracted/received/generated data while paired with the paired device 200. Among the contents of the memory 314, applications may be stored for execution by the processor 312 in order to carry out the functionality associated with each respective application. In some cases, the applications may include instructions for extraction of data from the paired device 200 and/or from the sensor network 220. Additionally or alternatively, the applications may include instructions for the reporting and/or processing of such information along with information generated locally at the wristband 140.

In some embodiments, the processing circuitry 310 may be configured to enable the wristband 140 to receive and analyze the operation information and the operator information to facilitate execution of the operational control functions. However, in other cases, the processing circuitry 310 may simply relay such information to the network 170 and/or user equipment 180 and any operational control functions may be performed based on instructions received from the network 170 and/or the user equipment 180. The operational control functions may include safety related functions such as, for example, providing alarms, notifications or other indications when certain situations are detected. For example, when the operator is within a predetermined distance of other users, when the user has a heart rate above a predetermined threshold that may indicate distress or an accident, when a manual distress call is made, when vibration or noise is at levels above standard or legal limits, or when an unauthorized user is attempting to use the device. Productivity related actions may also be taken. For example, a service indication linkage may be provided between the operator and the product to continuously monitor for when service should be done without returning the product to the workshop or garage. As another example of productivity related actions, optimization and/or product use recommendations may be provided (e.g., via the display 150) based on working data collections. In other situations, anti-theft actions may be taken including alarming or immobilizing equipment when an unauthorized user is detected, or when the device is removed from proximity to the wristband 140. The pairing process may also allow for product check in/out to be accomplished in a simple way, and to log users who use the product. GPS positioning of authorized operators (e.g., operators wearing wristbands and having qualification to operate a given device) may also be accomplished to determine when an authorized operator is nearby and should be called to take over or work on an important job. The wristband 140 may also allow linkage to a cell phone or the internet to allow tethering in certain cases.

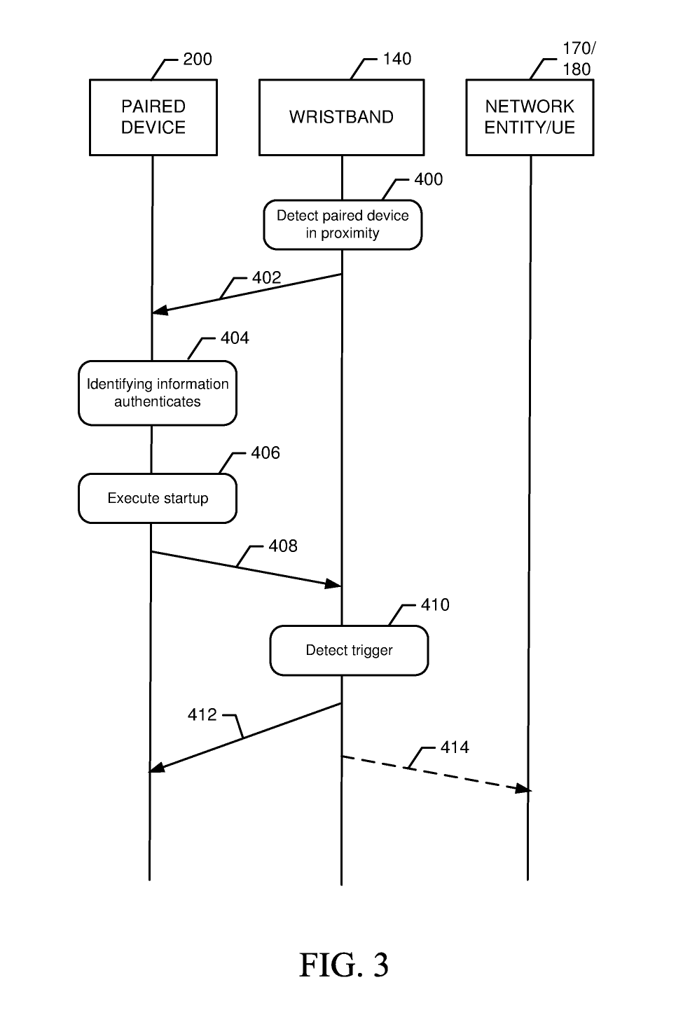

As can be appreciated from the example embodiments above, some embodiments may provide a wristband 140 that can provide operational control functions at a paired device. However, the execution of the operational control functions may take numerous different forms. FIGS. 3-5 illustrate various example control flow diagrams illustrating a series of communication operations associated with operation of the wristband 140 of an example embodiment. As shown in FIG. 3, the wristband 140 may initially detect the paired device 200 in proximity (or vice versa) and pairing information (e.g., identifying information identifying the operator) may be provided to the paired device 200 thereafter at operation 402. In some cases, the wristband 140 may have the specific identity of the operator, or may provide an operator classification code (e.g., indicating an authorization or training level) as the identifying information. The paired device 200 may determine whether the identifying information authenticates to enable startup or operation of the paired device at operation 404. If the operator is authorized to use the device, the operator may be allowed to execute a startup or otherwise operate the paired device 200 at operation 406. Operation information may then be provided to the wristband 140 at operation 408 on a continuous, periodic or event-driven basis. Thereafter, if the operation information, or operator information detected locally at the wristband 140, is such that a trigger event is detected at operation 410, then an operational control function may be initiated at operation 412. In some cases, information may be relayed on to an entity of the network 170 or to the user equipment 180 at operation 414.

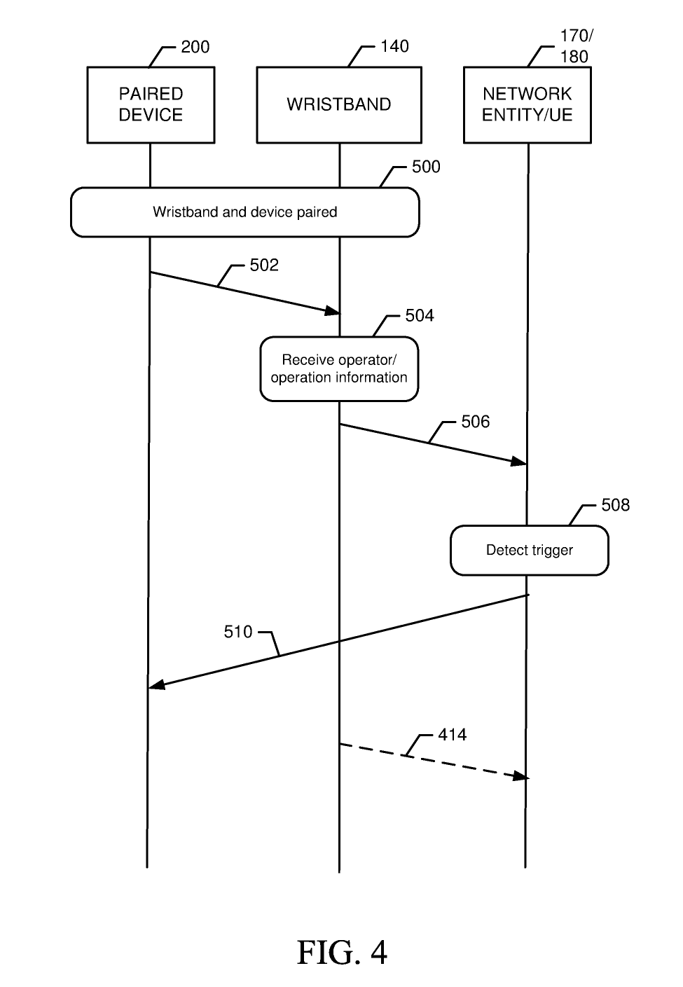

In an example embodiment, an entity of the network 170, or the user equipment 180, may take a more active role in operations in accordance with an example embodiment. For example, as shown in FIG. 4, the wristband 140 and paired device 200 may execute pairing by any suitable method at operation 500. The paired device 200 may then communicate operation information to the wristband 140 at operation 502. Simultaneously (or in any order), the wristband 140 may receive operator information at operation 504. The operator information and/or operation information may then be relayed to the user equipment 180 or an entity at the network 170 at operation 506. The occurrence of an event trigger may then be detected at the user equipment 180 or the entity at the network 170 at operation 508. Thereafter, at operation 510, an operational control function may be provided to the paired device 200 via the wristband 140.

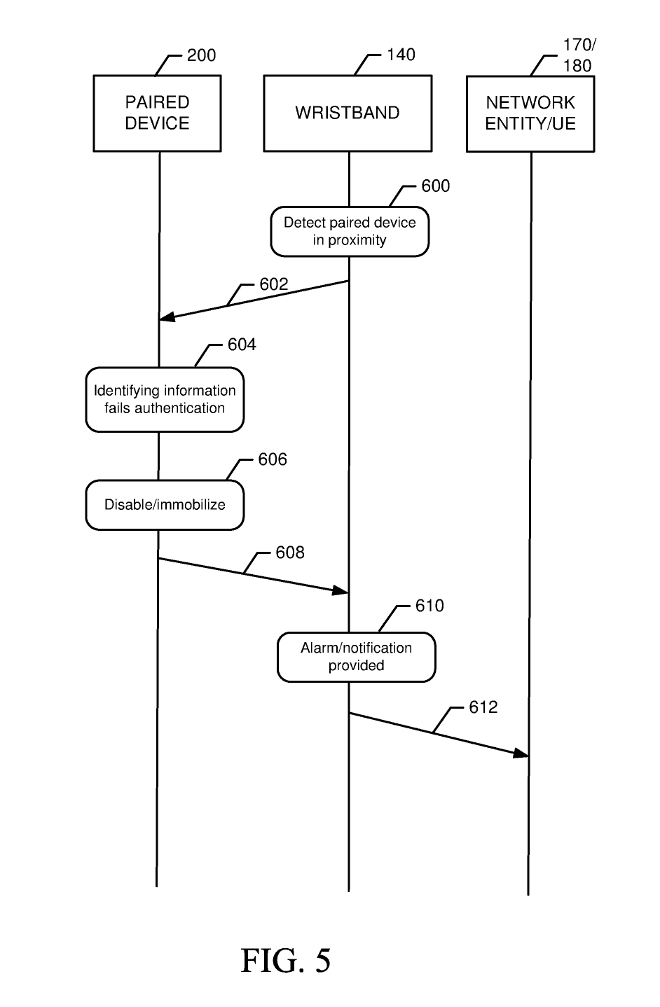

FIG. 5 illustrates an example in which a protective action is taken in accordance with an example embodiment. As shown in FIG. 3, the wristband 140 may initially detect the paired device 200 in proximity (or vice versa) and pairing information (e.g., identifying information identifying the operator, individually or by classification/qualification) may be provided to the paired device 200 thereafter at operation 502. As mentioned above, the wristband 140 may have the specific identity of the operator, or may provide an operator classification code (e.g., indicating an authorization or training level) as the identifying information. Alternatively, an RFID or other code reader may read a code provided by the wristband 140. The paired device 200 may attempt to determine whether the identifying information authenticates and, in this example, the authentication fails at operation 604. The paired device 200 may be actively or passively disabled/immobilized at operation 606. In other words, some action may actively be taken to prevent the paired device 200 from being operated or moved. Alternatively, the paired device 200 may simply not be enabled to operate or move in an example in which passive disabling/immobilization is employed. In some cases, the paired device 200 may further inform the wristband 140 of the failure at operation 608. The wristband 140 may issue an alarm or notification at operation 610. This may let the wearer of the wristband 140 know that a problem has occurred, so that corrective action can be taken. In some cases, the wristband 140 may further notify the user equipment 180 or an entity at the network 170 at operation 612. If a theft situation is applicable, authorities can be informed or other corrective action can be taken.

Accordingly, in one example embodiment, a wearable device is provided. The wearable device may be configured to be worn by an operator of outdoor power equipment may include processing circuitry having a processor and memory. The processing circuitry may be configured to communicate with a paired device during operation of the paired device over a first communication link. The processing circuitry may be further configured to provide an operational control function associated with operation of the paired device.

In some cases, modifications or amplifications may further be employed as optional alterations or augmentations to the description above. These alterations or augmentations may be performed exclusive of one another or in any combination with each other. In some cases, such modifications or amplifications may include (1), the wearable device further including one or more sensors configured to determine operator information. In such an example, the operator information may be a basis for the operational control function. In an example embodiment (2), the operator information may include measured physiological parameters of the operator. In some cases (3), the operator information may include vibration data or noise level measurement data. In some embodiments (4), operation information may be provided to the wearable device via the first communication link. In such an example, the operation information may be descriptive of parameters associated with the operation of the paired device. In an example embodiment (5), the operation information may include run time of the paired device, a number of on-off cycles of the paired device, GPS positioning of the wearable device, service data, or working data of the paired device. In some embodiments (6), the service data or working data provides a basis for the operational control function that may include providing operator feedback to improve operator productivity, providing an indication of service due, or initiating a safety related protective function. In some cases (7), the operational control function may include enabling or disabling operation of the paired device. In an example embodiment (8), the enabling or disabling of the paired device may be performed based on provision of identifying information of the operator to the paired device. In some cases (9), the operational control function may further include providing an alarm, locally or remotely, or immobilizing the paired device based on the identifying information. In some embodiments (10), the operational control function may include restricting one or more operational features of the paired device. In some cases (11), the wearable device may include a display configured to display operation information or operator information. In an example embodiment (12), the wearable device may include a function button configured to enable the operator to interface with the wearable device. In some cases (13), a distress signal is communicable to a network entity via a second communication link responsive to operation of the function button. In some embodiments (14), the wearable device is configured to wirelessly communicate with a network entity via a second communication link. In an example embodiment (15), the wearable device is configured to pair with a selected one of a plurality of different devices of the same type or of different device types.

In an example embodiment, some, any or all of modifications/amplifications (1) to (15) may be employed in any combination with each other.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A wearable device configured to be worn by an operator of outdoor power equipment, the wearable device comprising:
processing circuitry comprising a processor and memory, the processing circuitry being configured to communicate with a paired device during operation of the paired device over a first communication link, the processing circuitry being further configured to provide an operational control function associated with operation of the paired device.

2. The wearable device of claim 1, further comprising one or more sensors configured to determine operator information, wherein the operator information is a basis for the operational control function.

3. The wearable device of claim 2, wherein the operator information comprises at least one measured physiological parameter of the operator, or
wherein the operator information comprises vibration data or noise level measurement data.

4. (canceled)

5. The wearable device of claim 1, wherein operation information is provided to the wearable device via the first communication link, the operation information being descriptive of parameters associated with the operation of the paired device.

6. The wearable device of claim 5, wherein the operation information comprises run time of the paired device, a number of on-off cycles of the paired device, GPS positioning of the wearable device, service data of the paired device, or working data of the paired device.

7. The wearable device of claim 6, wherein the service data or working data provides a basis for the operational control function comprising providing operator feedback to improve operator productivity, providing an indication of service due, or initiating a safety related protective function.

8. The wearable device of claim 1, wherein the operational control function comprises enabling or disabling operation of the paired device.

9. The wearable device of claim 8, wherein the enabling or disabling of the paired device is performed based on provision of identifying information of the operator to the paired device, and
wherein the operational control function further comprises providing an alarm, locally or remotely, or immobilizing the paired device based on the identifying information.

10. (canceled)

11. The wearable device of claim 1, wherein the operational control function comprises restricting one or more operational features of the paired device.

12. The wearable device of claim 1, wherein the wearable device comprises a display configured to display operation information or operator information.

13. The wearable device of claim 1, wherein the wearable device comprises a function button configured to enable the operator to interface with the wearable device.

14. The wearable device of claim 13, wherein a distress signal is communicable to a network entity via a second communication link responsive to operation of the function button.

15. The wearable device of claim 1, wherein the wearable device is configured to wirelessly communicate with a network entity via a second communication link.

16. The wearable device of claim 1, wherein the wearable device is configured to pair with a selected one of a plurality of different devices of the same type or of different device types.

17. An outdoor power equipment device comprising:
a motor;
a working element operably coupled to the motor to be powered by the motor; and
communications circuitry configured to communicate with a wearable device worn by an operator of the outdoor power equipment device over a communication link,
wherein the wearable device provides an operational control function associated with operation of the outdoor power equipment device.

18. The outdoor power equipment device of claim 17, wherein the operational control function comprises enabling or disabling operation of the outdoor power equipment device.

19. The outdoor power equipment device of claim 18, wherein the enabling or disabling of the outdoor power equipment device is performed based on provision of identifying information of the operator to the outdoor power equipment device.

20. The outdoor power equipment device of claim 19, wherein the operational control function further comprises providing an alarm, locally or remotely, or immobilizing the outdoor power equipment device based on the identifying information.

21. A system comprising:
a wearable device configured to be worn by an operator of outdoor power equipment; and
a paired device configured to be paired with the wearable device via wireless communication over a first communication link, the paired device comprising a motor, a working element powered by the motor, and communication circuitry configured to communicate over the first communication link,
wherein the wearable device comprises processing circuitry configured to communicate with the paired device during operation of the paired device over the first communication link, the processing circuitry being further configured to provide an operational control function associated with operation of the paired device.

22. The system of claim 21, further comprising a network and user equipment operably coupled to the network, wherein the wearable device is configured to wirelessly communicate with the network and the user equipment via a second communication link.
